(19) United States
(12) Patent Application Publication
(10) Pub. No.: US 2017/0203652 A1
(43) Pub. Date: Jul. 20, 2017

(54) TRANSFER CASE WITH ACTIVE CLUTCH AND CHAIN DRIVE HAVING INTEGRATED CLUTCH DRUM/CHAIN SPROCKET

(71) Applicant: MAGNA POWERTRAIN OF AMERICA, INC., Troy, MI (US)

(72) Inventor: Bradley KETCHEL, Oxford, MI (US)

(21) Appl. No.: 15/000,237

(22) Filed: Jan. 19, 2016

(51) Int. Cl. B60K 17/342; F16D 13/52; B60K 17/02; F16H 7/08; F16H 7/06

(52) U.S. Cl. CPC B60K 17/342; F16H 7/0827; F16H 7/06; B60K 17/02; F16D 13/52

(57) ABSTRACT

An active transfer case having an integrated torque transfer component combining a multi-plate mode clutch with a sprocket of a chain and sprocket transfer assembly to provide a stacked arrangement therebetween.

### FIELD

The present disclosure relates generally to power transfer systems for controlling the distribution of drive torque from a powertrain to front and rear drivelines of a four-wheel drive motor vehicle. More particularly, the present disclosure is directed to a compact transfer case configured to integrate a sprocket of a chain drive transfer assembly with a clutch drum of an actively-controlled multi-plate friction clutch assembly.

### BACKGROUND

This section provides background information which is not necessarily prior art to the inventive concepts associated with the present disclosure.

Interest in four-wheel drive vehicles has led to development of power transfer systems configured to selectively and/or automatically direct rotary power (i.e. drive torque) from the powertrain to all four wheels of the vehicle. In many four-wheel drive vehicles, the power transfer system includes a transfer case configured to drivingly interconnect the powertrain to front and rear drivelines. More particularly, a majority of current transfer cases are configured to include a mainshaft or rear output shaft interconnecting the powertrain to the rear driveline, a front output shaft interconnected to the front driveline, a transfer assembly drivingly interconnected to the front output shaft, a mode clutch for selectively coupling the transfer assembly to the rear output shaft, and a clutch actuator for controlling actuation of the mode clutch. The mode clutch is operable in a first or “released” state to disconnect the front output shaft from the rear output shaft and establish a two-wheel drive mode (2WD) with all drive torque transmitted from the powertrain to the rear driveline. The mode clutch is also operable in a second or “engaged” state to drivingly connect the front output shaft (via the transfer assembly) to the rear output shaft and establish a four-wheel drive mode (4WD) with drive torque transmitted from the powertrain to both of the front and rear drivelines. Additionally, some two-speed transfer cases are equipped with a geared reduction unit operably disposed between the powertrain and the rear output shaft, and a range clutch that can be actuated for selectively establishing a direct ratio drive connection and a reduced ratio drive connection therebetween for providing four-wheel high-range and low-range drive modes.

Some “part-time” transfer cases are equipped with a positive-locking type of mode clutch, such as a dog clutch, which can be selectively actuated to shift between the two-wheel drive mode (2WD) and a locked four-wheel drive mode (LOCK-4WD). As an alternative, “active” transfer cases are equipped with an on-demand mode clutch, such as an adaptively-controlled multi-plate friction clutch, configured to automatically control the drive torque distribution between the front and rear drivelines without any input or action on the part of the vehicle operator so as to provide an on-demand four-wheel drive mode (AUTO-4WD) in addition to the two-wheel drive mode (2WD). Typically, active transfer cases also include a power-operated clutch actuator that is interactively associated with an electronic traction control system having a plurality of vehicle sensors. The power-operated clutch actuator regulates the magnitude of a clutch engagement force applied to the multi-plate friction clutch based on vehicular and/or road conditions detected by the sensors, thereby adaptively regulating the drive torque distribution ratio between the front and rear drivelines. This adaptive clutch control system can also be used in actively-controlled full-time transfer cases to automatically bias the torque distribution across an interaxle differential.

A majority of current transfer cases are also equipped with a chain and sprocket type of transfer assembly which typically includes a first sprocket rotatably supported on the rear output shaft, a second sprocket fixed for common rotation with the front output shaft, and a continuous chain encircling and drivingly interconnecting the first sprocket for common rotation with the second sprocket. The mode clutch is typically axially offset with respect to the first sprocket and disposed to surround the rear output shaft. Functionally, the mode clutch is operable to selectively/automatically couple the first sprocket to the rear output shaft so as to transfer drive torque to the front output shaft through the chain and sprocket transfer assembly. Thus, the axial dimensions of the first sprocket and the components of the mode clutch, as well as other components associated with the rear output shaft, largely dictate the overall axial length of the transfer case.

In the past, the vehicle ride height and suspension configuration for traditional four-wheel drive vehicles (i.e. trucks and sport utility vehicles) provided sufficient packaging volume to accommodate conventional part-time and active transfer cases. However, in view of increased demand for smaller four-wheel drive vehicles, the packaging volume allocated to the powertrain and the transfer case has been significantly reduced. To accommodate reduced packaging space requirements, alternative transfer case configurations have been developed. For example, commonly-owned U.S. Pat. No. 8,316,783 discloses an active transfer case having a traditional rear output shaft and mode clutch configuration now associated with a beveloid gearset type of transfer assembly and an angulated front output shaft arrangement. Alternatively, some transfer cases have been developed which locate the mode clutch and actuator components on the front output shaft as shown, for example, in U.S. Pat. No. 8,157,072.

While such alternative transfer case configurations attempt to address the recognized need for reduced packaging requirements, a need continues to exist to advance the technology and structure of transfer cases in a manner which provides enhanced configurations that improve upon otherwise conventional packaging arrangements.

### SUMMARY

This section provides a general summary of the inventive concepts associated with the present disclosure and is not intended to be interpreted as a complete and thoroughly comprehensive disclosure of all of its aspects, features, advantages and objectives.

It is an aspect of the present disclosure to provide a transfer case having reduced packaging requirements associated with a compact mode clutch and power transfer arrangement.

It is another aspect of the present disclosure to provide a transfer case for use in a four-wheel drive vehicle that is configured to provide a reduced axial length requirement by integrating components of a transfer assembly with components of a mode clutch to provide the compact mode clutch and power transfer arrangement.

It is a related aspect of the present disclosure to provide an active transfer case configured to integrate a clutch drum of an actively-controlled multi-plate mode clutch with a drive sprocket of a chain and sprocket type of transfer assembly to define an integrated torque transfer component.

It is another related aspect of the present disclosure to provide a part-time transfer case configured to integrate a clutch ring of a mechanically-actuated mode clutch with a drive sprocket of a chain and sprocket type of transfer assembly to define another integrated torque transfer component.

It is another aspect of the present disclosure to provide a transfer case having the integrated mode clutch and power transfer arrangement associated with the rear output shaft. In an alternative aspect, the transfer case of the present disclosure has the integrated mode clutch and power transfer arrangement associated with the front output shaft.

In accordance with these and other aspects, the present disclosure is directed to a transfer case for use in four-wheel drive motor vehicles to interconnect the powertrain to first and second drivelines. The transfer case is constructed to include a first shaft configured to transmit drive torque from the powertrain to the first driveline, a second shaft adapted for connection to the second driveline, and an integrated mode clutch and power transfer arrangement configured to selectively and/or automatically transmit drive torque from the first shaft to the second shaft. The integrated mode clutch and power transfer arrangement combines a clutch component of a mode clutch with a transfer component of a transfer assembly to define an integrated torque transfer component.

In accordance with an embodiment of the present disclosure, the integrated torque transfer component combines a clutch drum of a multi-plate friction mode clutch with a sprocket of a chain and sprocket type of transfer assembly to define a sprocket drum. The sprocket drum includes an axially-extending drum segment having sprocket teeth formed on its outer surface and spline teeth formed on its inner surface. The sprocket teeth are configured to be encircled and meshed with a chain of the chain and sprocket transfer assembly while the spline teeth are configured to engage clutch plates associated with a clutch pack of the mode clutch.

Further areas of applicability will become apparent from the description provided herein. As noted, the description and specific embodiments disclosed in this summary are intended for purposes of illustration only and are not intended to limit the scope of the present disclosure.

### DRAWINGS

The drawings described herein are only for purposes of illustrating selected embodiments and not all implementations or variations thereof. As such, the drawings are not intended to limit the scope of the inventive concepts associated with the present disclosure. In the drawings:

FIG. 1 is a schematic illustration of a four-wheel drive motor vehicle configured to be equipped with various embodiments of transfer cases that are constructed in accordance with the teachings of the present disclosure;

FIG. 2 is a diagrammatical illustration of a transfer case constructed in accordance with a first non-limiting embodiment of the present disclosure;

FIG. 3 is a sectional view of a transfer case constructed in accordance with the embodiment shown in FIG. 2;

FIG. 4 is an enlarged partial view of a compact mode clutch and power transfer arrangement associated with the transfer case shown in FIG. 3;

FIG. 5 is a sectional view showing a power-operated clutch actuator for actuating a multi-plate mode clutch associated with the transfer case shown in FIGS. 3 and 4;

FIG. 6 is a partial sectional view of a transfer case constructed in accordance with a second non-limiting embodiment of the present disclosure;

FIG. 7 is a diagrammatical view of a transfer case constructed in accordance with a third non-limiting embodiment of the present disclosure; and

FIG. 8 is another diagrammatical view of a transfer case constructed in accordance with a fourth non-limiting embodiment of the present disclosure.

Corresponding reference numerals are used throughout the various views provided in the above-noted drawings to identify common components.

### DETAILED DESCRIPTION

Example embodiments of a transfer case for use in four-wheel drive vehicles having a compact mode clutch and power transfer arrangement will now be described. However, these specific example embodiments are provided so that this disclosure will be thorough and will fully convey the intended scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known device structures and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

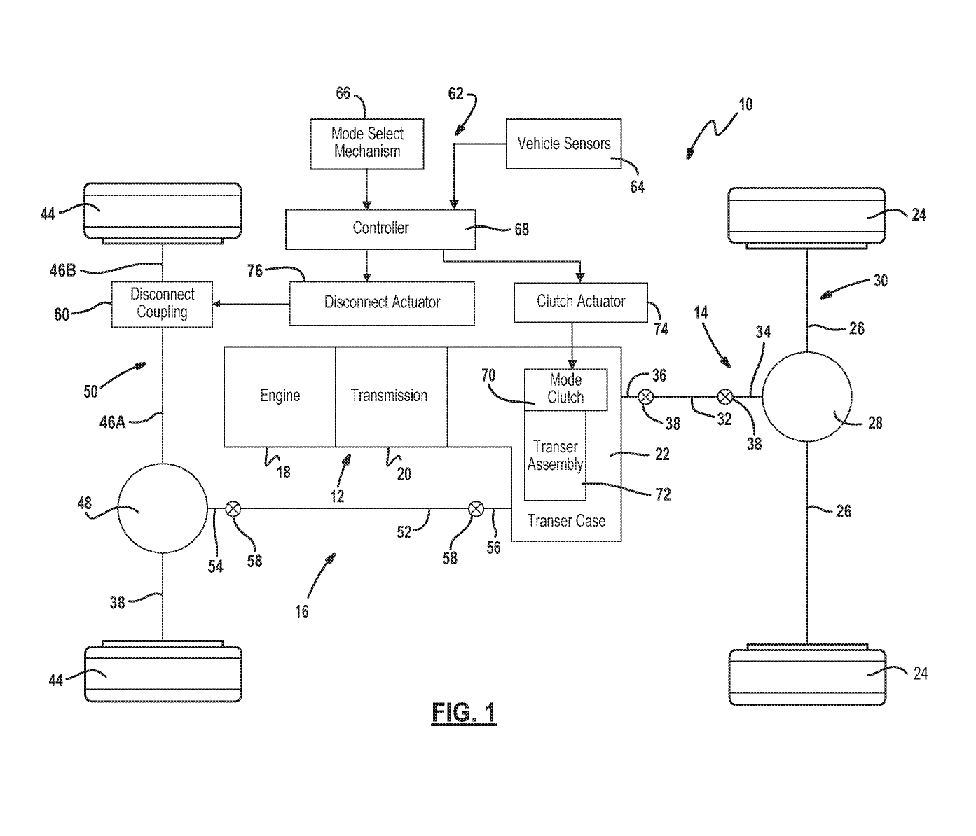

Referring initially to FIG. 1 of the drawings, an example of a four-wheel drive motor vehicle 10 is shown to generally include a longitudinally-extending (i.e. north/south configuration) powertrain 12 operable for generating rotary power (i.e. drive torque) to be transmitted to a first or rear driveline 14 and a second or front driveline 16. Powertrain 12 is shown to include an internal combustion engine 18, a multi-speed transmission 20, and a transfer case 22. In the particular arrangement shown, rear driveline 14 is the primary driveline and is configured to include a pair of ground-engaging rear wheels 24 drivingly connected via corresponding rear axleshafts 26 to a rear differential assembly 28 associated with a rear axle assembly 30. Rear driveline 14 also includes a rear propshaft 32 arranged to interconnect a rotary input 34 of rear differential assembly 28 to a rear output shaft 36 of transfer case 22. A pair of rear joint units 38 are shown to interconnect opposite ends of rear propshaft 32 to rotary input 34 of rear differential assembly 28 and rear output shaft 36 of transfer case 22 and which function to transmit drive torque while permitting angular and/or translational movement therebetween.

Front driveline 16 is the secondary driveline and is shown in FIG. 1 of the drawings configured to include a pair of front ground-engaging wheels 44 drivingly interconnected via corresponding front axleshafts 46 to a front differential assembly 48 associated with a front axle assembly 50. Front driveline 16 also includes a front propshaft 52 arranged to interconnect a rotary input 54 of front differential assembly 48 to a front output shaft 56 of transfer case 22. A pair of front joint units 58 interconnect opposite ends of front propshaft 52 to rotary input 54 of front differential assembly 48 and front output shaft 56 of transfer case 22 and function to transmit drive torque while permitting angular and/or translational movement therebetween. A disconnect coupling 60 is also associated with front driveline 16 and is shown operably disposed between a pair of shaft segments 46A, 46B of one of front axleshafts 46. Disconnect coupling 60 is operable in a first or “connected” mode to drivingly couple front wheels 44 to the remainder of front driveline 16 and is further operable in a second or “disconnected” mode to uncouple front wheels 44 from driven connection with the reminder of front driveline 16.

Powertrain 12 is also shown in FIG. 1 to be operably associated with a powertrain control system 62 generally including a group of vehicle sensors 64 and a mode selector 66, both of which provide signals which communicate with a vehicle controller 68. Vehicle controller 68 can include one or more individual controllers associated with engine 18, transmission 20, transfer case 22 and disconnect coupling 60 which are configured to control motive operation of vehicle 10. Powertrain control system 62 is shown to provide an electronically-controlled power transfer system configured to permit a vehicle operator to select between a two-wheel drive (2WD) mode, a part-time or “locked” four-wheel drive (LOCK-4WD) mode, and an adaptive or “on-demand” four-wheel drive (AUTO-4WD) mode. In this regard, transfer case 22 is equipped with a mode clutch 70 and a transfer assembly 72 configured to transfer drive torque to front driveline 16 when one of the four-wheel drive modes is selected. As will be detailed hereafter with greater specificity, mode clutch 70 functions to selectively transmit drive torque from rear output shaft 36 to front output shaft 56 via transfer assembly 72.

The power transfer system is shown to also include a power-operated clutch actuator 74 for controlling actuation of mode clutch 70, and a power-operated disconnect actuator 76 for controlling actuation of disconnect coupling 60. Controller 68 controls coordinated actuation of actuators 74, 76 in response to input signals from vehicle sensors 64 and mode signals from mode select mechanism 66. Vehicle sensors 64 are arranged and configured to detect certain dynamic and operational characteristics of vehicle 10 and/or current weather or road conditions.

To establish the 2WD mode, clutch actuator 74 is controlled to shift mode clutch 70 into a first or “released” mode while disconnect actuator 76 is controlled to shift disconnect coupling 60 into its disconnected mode. With mode clutch 70 in its released mode, no drive torque is transmitted through transfer assembly 72 to front output shaft 56 such that all drive torque generated by powertrain 12 is delivered to rear wheels 24 via rear driveline 14.

To establish the LOCK-4WD mode, disconnect actuator 76 is controlled to shift disconnect coupling 60 into its connected mode and clutch actuator 74 is controlled to shift mode clutch 70 into a second or “fully-engaged” mode. With mode clutch 70 operating in its fully-engaged mode, rear output shaft 36 is, in effect, drivingly coupled to front output shaft 56 via transfer assembly 72 such that drive torque is equally distributed (i.e. 50/50) therebetween. With disconnect coupling 60 in its connected mode, shaft segments 46A, 46B are drivingly coupled together such that drive torque delivered to front output shaft 56 is transferred via front driveline 16 to front wheels 44.

To establish the AUTO-4WD mode, disconnect coupling 60 is shifted into, or maintained in, its connected mode and clutch actuator 74 operates to adaptively regulate the drive torque distribution between rear output shaft 36 and front output shaft 56 by varying operation of mode clutch 70 between its released and fully-engaged modes. The torque distribution ratio is based on and determined by control logic associated with controller 68 which is configured to determine a desired or “target” amount of the total drive torque to be transmitted to front output shaft 56 based on the operating characteristics and/or road conditions detected by sensors 64.

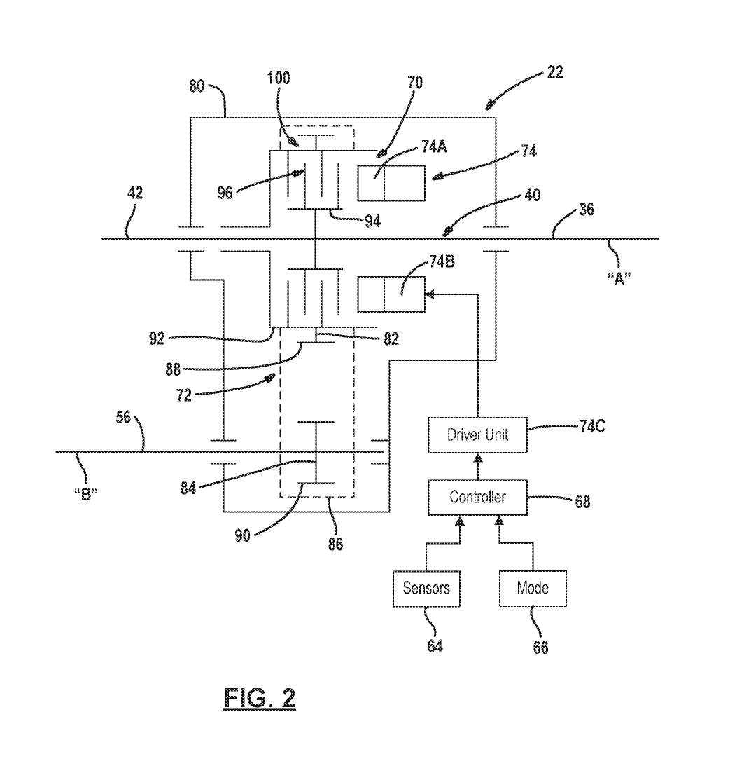

Referring now to FIG. 2 of the drawings, a first non-limiting embodiment of a transfer case 22 will now be described in detail. Transfer case 22 generally includes a t-case housing 80, rear output shaft 36, front output shaft 56, transfer assembly 72, mode clutch 70, and power-operated clutch actuator 74. In accordance with the teachings of the present disclosure, a component of transfer assembly 72 is combined with a component of mode clutch 70 to define an “integrated torque transfer component” which facilitates a compact “stacking” arrangement between mode clutch 70 and transfer assembly 72. This stacked arrangement results in a reduced axial packaging of transfer case 22 in comparison to otherwise conventional (i.e. “unstacked”) arrangements in known transfer cases. In the particular example disclosed, the integrated torque transfer component combines a first transfer member or first sprocket 82 of transfer assembly 72 with a first clutch member or clutch drum 92 of mode clutch 70, hereinafter the combined component being cumulatively referred to as a sprocket drum 100. Sprocket drum 100 is rotatably supported on rear output shaft 36.

In addition to first sprocket 82, transfer assembly 72 also includes a second transfer member or second sprocket 84 that is fixed to, or formed integrally with, front output shaft 56, and a continuous power chain 86 encircling and meshed with first sprocket teeth 88 formed on first sprocket 82 of sprocket drum 100 and with second sprocket teeth 90 formed on second sprocket 82. In the non-limiting embodiment shown, transfer assembly 72 is of the chain and sprocket type of drive torque transfer arrangement. Transfer case 22, as shown in FIG. 2, is a one-speed configuration with a mainshaft 40 having an input shaft 42 and rear output shaft 36 formed integrally into a common shaft. Input shaft 42 is adapted to be drivingly connected to an output shaft (not shown) of transmission 20 so as to receive the drive torque from powertrain 12.

With continued attention to FIG. 2, transfer case 22 is shown with mainshaft 40, mode clutch 70, and clutch actuator 74 operably arranged with respect to a first rotary axis “A”. Mode clutch 70 is shown, in this non-limiting configuration, to be a multi-plate friction clutch generally including clutch drum 92 rotatably supported on mainshaft 40, a second clutch member or clutch hub 94 fixed for rotation with mainshaft 40, and a multi-plate clutch pack 96 comprised of a plurality of interdigitated first and second clutch plates. The first clutch plates are coupled via a splined or lugged drive connection 98 with clutch hub 94 while the second clutch plates are coupled via a splined or lugged drive connection 102 with clutch drum 92. As will be detailed hereinafter, first sprocket teeth 88 of first sprocket 82 and the internal splines/lugs associated with drive connection 102 are formed in associated with sprocket drum 100 to provide the integrated torque transfer component.

Power-operated clutch actuator 74 is schematically shown in FIG. 2 to surround mainshaft 40 in proximity to clutch pack 96 and is configured to include a moveable actuation component that is adapted to engage and apply a compressive clutch engagement force on clutch pack 96. As will be understood, movement of this actuation component in an engagement direction (i.e. toward clutch pack 96) increases the magnitude of the clutch engagement force and the corresponding amount of drive torque transferred from mainshaft 40 to front output shaft 56 via transfer assembly 72. Likewise, movement of the actuation component in a releasing direction (i.e. away from clutch pack 96) decreases the magnitude of the clutch engagement force and the corresponding amount of drive torque transmitted from mainshaft 40 to front output shaft 56 via transfer assembly 72. Clutch actuator 74 is shown, in this non-limiting embodiment, to generally include a pressure plate 74A, a force generating mechanism 74B, and a powered driver unit 74C. Force generating mechanism 74B is powered by powered driver unit 74C and is operable to generate and exert the axially-directed clutch engagement force. Powered driver unit 74C can include, without limitations, an electric motor, an electromagnetic actuator, a hydraulic power pack (i.e., motor-driven fluid pump) or the like. Similarly, force generating mechanism 74B may include, without limitation, a rotary-to-linear conversion device (i.e., ball ramp unit, spindle-drive unit, etc.) a pivot actuator or a linear actuator.

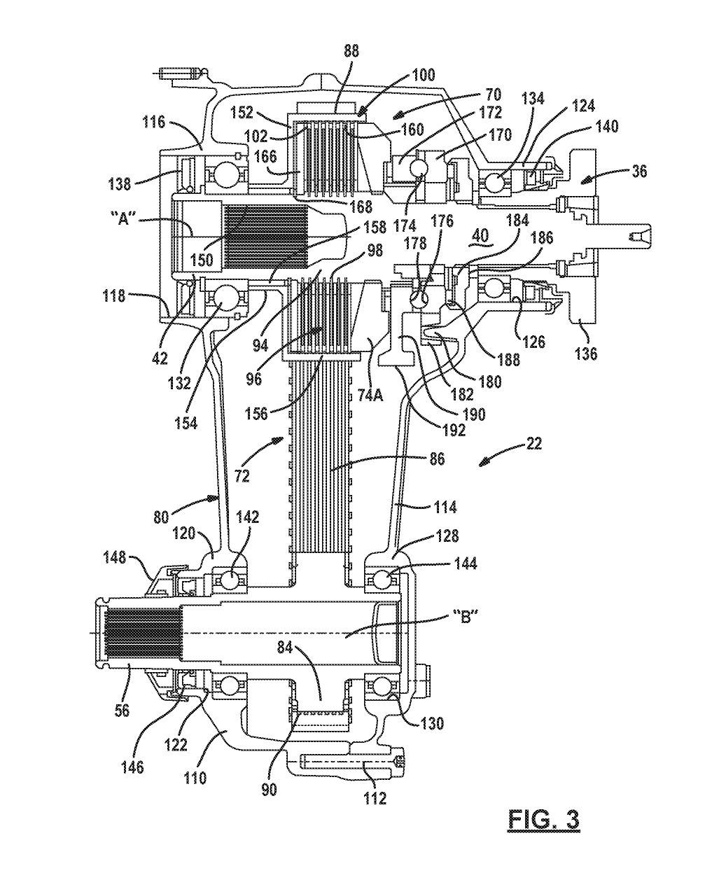

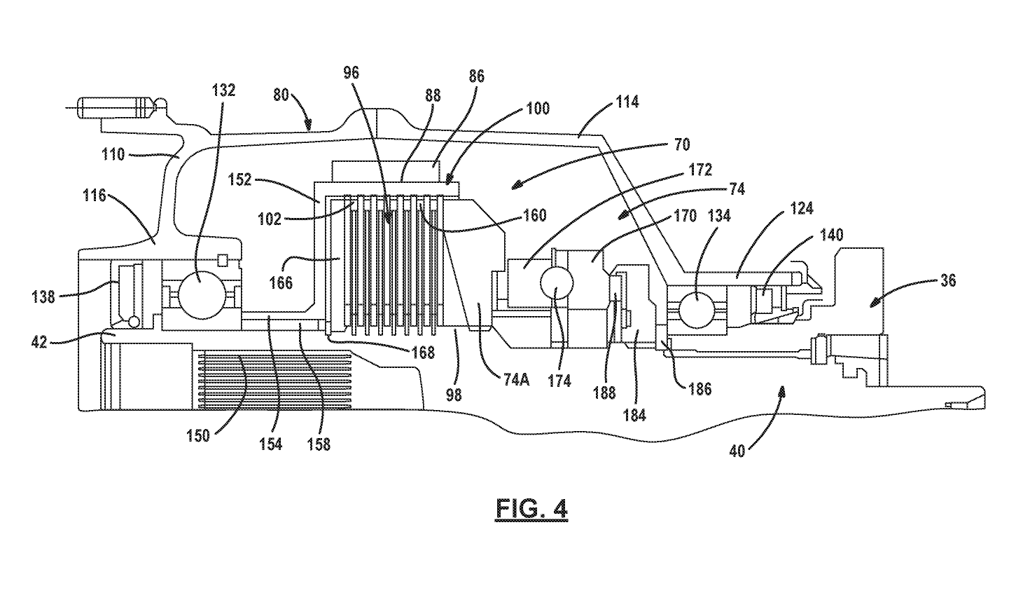

Referring now to FIGS. 3 and 4, sectional views of a non-limiting embodiment of transfer case 22 is shown with mainshaft 40 aligned for rotation about first rotary axis “A” while front output shaft 56 is shown aligned for rotation about a second rotary axis “B”. Housing 80 is shown as a two-piece construction having a first housing section 110 secured via a plurality of fasteners 112 to a second housing section 114. First housing section 110 includes an annular input boss segment 116 defining an input aperture 118, and an annular front output boss segment 10 defining a front output aperture 122. Second housing section 114 includes an annular rear output boss segment 124 defining a rear output aperture 126, and an annular front output boss segment 128 defining a bearing support cavity 130. A first bearing assembly 132 is shown rotatably supporting input shaft 42 of mainshaft 40 in input aperture 118, while a second bearing assembly 134 is shown rotatably supporting a yoke coupling 136 of rear output shaft 36 in rear output aperture 126. First and second rotary seals 138, 140 are also respectively disposed within input aperture 118 and rear output aperture 126. A third bearing assembly 142 is shown rotatably supporting one portion of front output shaft 56 within front output aperture 122, while a fourth bearing assembly 144 rotatably supports another portion of first output shaft 56 within bearing support cavity 130. A rotary seal 146 is also disposed within front output aperture 122 while a deflector ring 148 fixed for rotation with front output shaft 56 generally surrounds front output boss segment 120 of first housing section 114. Input shaft 42 of mainshaft 40 is shown to include an internally-splined drive cavity 150 adapted to receive and mesh with an externally-splined output shaft (now shown) of transmission 20.

With continued reference to FIGS. 3 and 4, sprocket drum 100 of the radially stacked and integrated arrangement between transfer assembly 72 and mode clutch 70 is generally shown to include a radial plate segment 152, a smaller diameter axially-extending tubular hub segment 154, and a larger diameter axially-extending sprocket/drum segment 156. Hub segment 154 of sprocket drum 100 surrounds input shaft 42 of mainshaft 40 and is rotatably supported thereon via a fifth bearing assembly 158. The external peripheral surface of sprocket/drum segment 156 includes first sprocket teeth 88 which extend outwardly therefrom while the internal peripheral surface of sprocket/drum segment 156 includes internal spline teeth 160 configured to mesh with the external spline teeth of the second clutch plates of clutch pack 96 to define drive connection 102. Preferably, first sprocket teeth 88 and internal spline teeth 160 are integrally formed to extend from sprocket/drum segment 156 of sprocket drum 100. Clutch hub 94 is shown to be integrally formed on an intermediate portion of mainshaft 40 and has external spline teeth 162 configured to mesh with the internal spline teeth of the first clutch plates of clutch pack 96 to define drive connection 98 therebetween. Mode clutch 70 is also shown to include a reaction plate 166 fixed for rotation with mainshaft 40 and which is positively axially located within a clutch chamber formed between radial plate segment 152 and sprocket drum segment 156 of sprocket drum 100 via a retainer ring 168. Reaction ring 166 is configured to react the axially-directed clutch engagement forces applied to clutch pack 96 within the clutch chamber so as to minimize the loading applied to sprocket drum 100.

Force generating mechanism 74B is shown in the non-limiting embodiment disclosed in FIGS. 3 and 4 to include a ball-ramp unit having a stationary first cam ring 170, a moveable second cam ring 172, and a plurality of balls 174 each disposed between an aligned pair of first and second cam tracks 176, 178 that are respectively formed in first and second cam rings 170, 172. Stationary first cam ring 140 is restrained rotationally via engagement of an anti-rotational lug 180 extending from second housing section 114 within an anti-rotation aperture 182 formed in first cam ring 170. Likewise, first cam ring 170 is axially restrained adjacent to a locator plate 184. Locator plate 184 is fixed (i.e. splined) for rotation with rear output shaft 36 and is axially restrained via a retainer ring 186. A sixth bearing assembly, in the form of a radial needle bearing unit 188, is disposed between locator plate 184 and first cam ring 170.

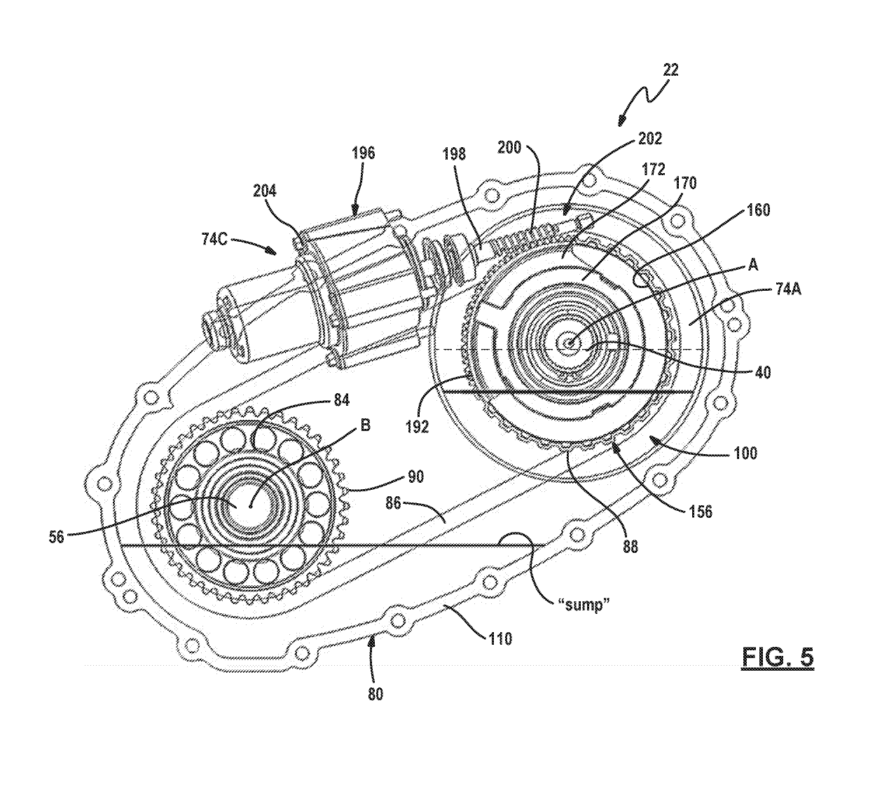

Second cam ring 172 is configured to be both rotatably moveable and axially moveable relative to first cam ring 170 to create and transfer a clutch engagement force through pressure plate 74A to clutch pack 96. Second cam ring 172 is shown to include a sector-shaped extension 190 having gear teeth 192 formed along its peripheral edge surface. Rotation of second cam ring 172 relative to first cam ring 170 is caused by rotation of a toothed output component of powered driver unit 74C that is meshed with sector gear teeth 192. As a result of rotation of second cam ring 172 relative to first cam ring 170, second cam ring 172 translates axially in one of a first or “engaging” direction toward clutch pack 96 and a second or “releasing” direction away from clutch pack 96 based on the direction of rotation provided by the powered driver unit 74C. FIG. 5 illustrates that powered driver unit 74C of clutch actuator 74 includes an electric motor 196 having a rotary motor shaft 198 driving a worm 200. Threads of worm 200 are meshed with sector gear teeth 192 to define a reduction gearset 202. Motor 196 is secured, such as by fasteners 204, to second housing section 114 of housing 80.

Rotation of worm 200 in a first direction causes rotation of second cam ring 172 in a first rotary direction which, in turn, causes corresponding axial movement of second cam ring 172 in its releasing direction (right in drawings) to permit a biasing spring (not shown) to move pressure plate 74A in a releasing direction and placing mode clutch 70 in its released mode. In contrast, rotation of worm 200 in a second rotary direction causes rotation of second cam ring 172 in a second rotary direction which, in turn, causes corresponding axial movement of second ram ring 172 in its engaging direction (left in drawings) for forcibly moving pressure plate 74A in an engaging direction and shifting mode clutch 70 from its released mode into its engaged mode. The configuration of the aligned pairs of first and second cam tracks 176, 178 acts to coordinate the relationship between rotation and axial translation of second cam ring 172 relative to first cam ring 170.

As noted, the combination of clutch drum 92 associated with mode clutch 70 and drive sprocket 82 associated with transfer assembly 70 in a radially stacked arrangement provides transfer case 22 with a compact mode clutch and power transfer configuration. Sprocket teeth 88 (formed on exterior surface of sprocket/drum segment 156) and spline teeth 160 (formed on interior surface of sprocket/drum segment 156) can include complimentary profiles or, in the alternative, be formed with non-complimentary profiles. Sprocket drum 100 can be a net formed component or a machined component. The radial dimension of transfer case 22 is not detrimentally impacted since chain 86 encircles and rides directly on sprocket teeth 88 formed directly on the external surface of sprocket drum 100.

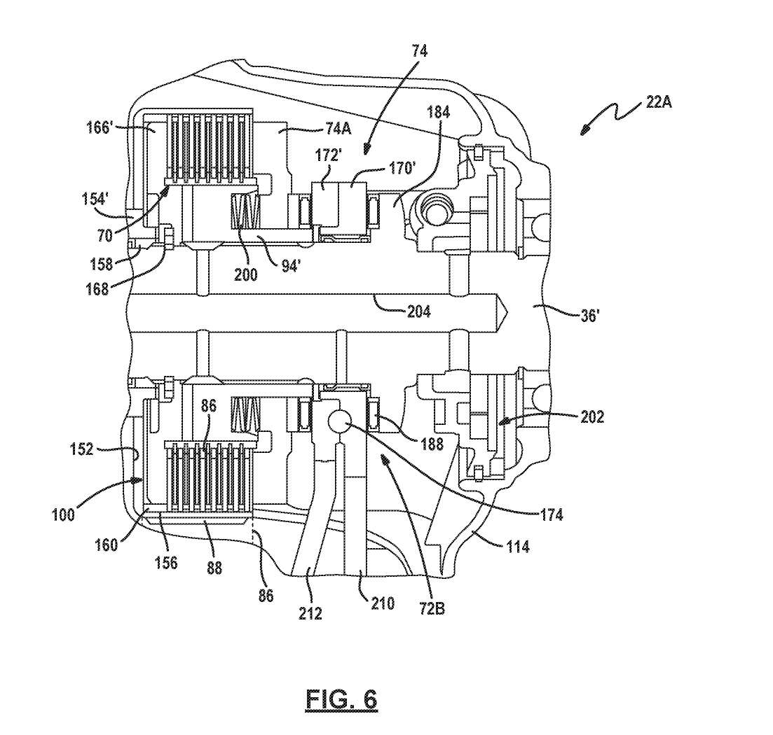

FIG. 6 is a partial sectional view of a slightly revised version of transfer case 22 shown in FIGS. 3 and 4, and which is identified hereafter as transfer case 22A. Similar components of transfer case 22A to those previously disclosed will be identified with common reference numerals. In general, transfer case 22A is substantially similar in structure and function to that of transfer case 22 with the exceptions noted in the following. Transfer case 22A can be used with two-speed gear reduction units configured to interconnect rear output shaft 36′ to the transmission output shaft at one of a direct drive ratio and a reduced ratio connection. The two-speed gear reduction unit would include an input shaft rotatably supported in first housing section 110 of housing 80, a planetary gearset driven by the input shaft, a sliding range clutch operable in a first range position to directly couple rear output shaft 36 to the input shaft and in a second range position to couple rear output shaft 36 to an output component of the planetary gearset, and a range shift system for controlling movement of the range clutch. The range shift system can be combined with the mode clutch shift system to coordinate actuation of the range clutch and mode clutch 70.

FIG. 6 also shows transfer case 22A to now be equipped with a separate clutch hub 94′ that is splined to rear output shaft 36 and has reaction plate 166′ integrally formed therewith. A return spring 200 is shown for normally biasing pressure plate 74A in the releasing direction. A geroter lube pump 202 is driven by rear output shaft 36′ and delivers lubricant from a sump to a central lube passage 204 formed in rear output shaft 36′ for subsequent delivery of the lubricant to ball ramp unit 74B and mode clutch 70. Hub segment 154′ of sprocket drum 100 is a separate component. Likewise, sprocket drum 100 includes a bell-shaped component which defines radial plate segment 152 and drum segment 156. Hub segment 154′ and radial plate segment 152 are rigidly secured together such as by welding. Additionally, first cam ring 170′ is shown to include a first lever extension 210 and second cam ring 172′ is shown to include a second lever extension 212. Lever extensions 210, 212 extend toward and engage opposite portions of a rotary cam component driven by powered driver unit 74C (i.e. electric motor) to control relative rotation of second cam ring 172′ relative to first cam ring 170′ or, in the alternative, relative rotation due to rotary movement of both cam rings.

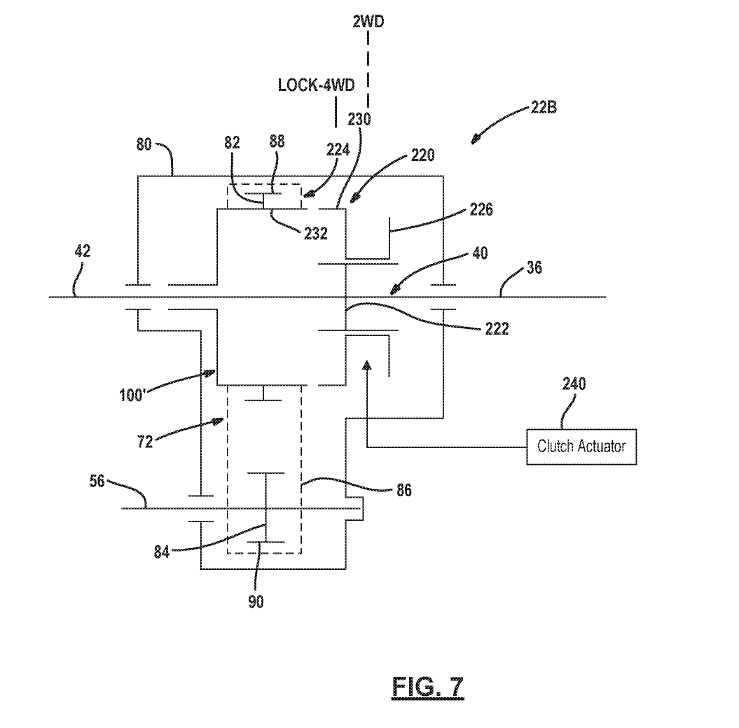

FIG. 7 is a schematic illustration of another alternative embodiment of a transfer case, hereinafter referred to as part-time transfer case 22B. Transfer case 22B is generally a revised version of transfer case 22 shown in FIG. 2 which substitutes a positive locking type of mode clutch 220 for actively-controlled mode clutch 70. In particular, mode clutch 220 is shown to include a clutch hub 222 fixed for rotation with mainshaft 40, a combined sprocket/clutch ring 224 rotatably supported on mainshaft 40, and a mode sleeve 226 splined for rotation with, and axial sliding movement on, clutch hub 222. The combined sprocket/clutch ring 224 defines an integrated torque transfer component, also identified as a sprocket clutch ring 100′. Mode sleeve 226 is moveable on clutch hub 222 between a first or 2WD mode position and a second or LOCK-2WD mode position. In the 2WD position, external dog teeth 230 on mode sleeve 226 are disengaged from meshed engagement with internal clutch teeth 232 formed in the internal peripheral surface of sprocket clutch ring 100′, whereby transfer assembly 72 does not transfer drive torque to front output shaft 56. In the LOCK-4WD mode position, external dog teeth on mode sleeve 226 are in meshed engagement with internal clutch teeth 232 in sprocket clutch ring 100′, whereby rear output shaft 36 and first output shaft 56 are coupled for common rotation via transfer assembly 72. A clutch actuator 240 is shown schematically for controlling movement of mode sleeve 226 between its two distinct mode positions. Clutch actuator 240 can be actuated manually by the vehicle operator (mechanical connection via mode shift lever in passenger compartment) or automatically via operation of a powered driver unit in response to detection of a mode signal from mode selector 66 indicative of the desired drive mode. Sprocket teeth 88 of first sprocket 82 are again provided on the outer peripheral surface of sprocket clutch ring 100′. Preferably, sprocket teeth 88 and clutch teeth 232 are integrally formed on combined sprocket/clutch ring 224 and provide a radially stacked and axially compact mode clutch and power transfer arrangement. While shown schematically, it is to be understood that the axially-extending cylindrical segment of sprocket/clutch ring 100′ has radially outwardly extending sprocket teeth 88 formed directly on its outer surface and has radially inwardly extending clutch teeth 232 formed directly on its inner surface.

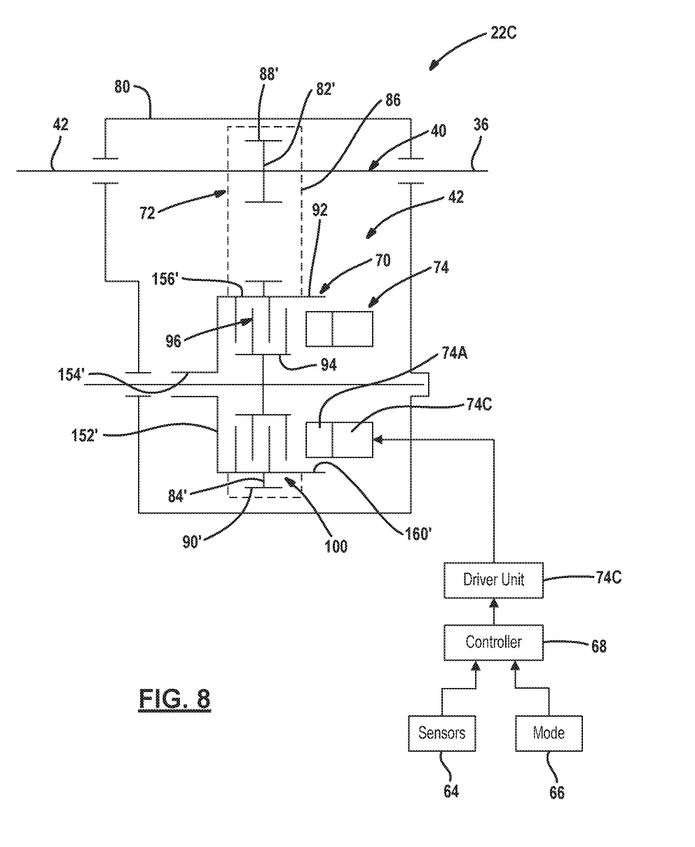

Referring to FIG. 8, another alternative embodiment of a transfer case, hereinafter referred to as transfer case 22C, is schematically shown to be a revised version of transfer case 22 of FIG. 2. Specifically, mode clutch 70 and clutch actuator 74 are now shown to be associated with front output shaft 56. Thus, first sprocket 82′ is an otherwise conventional sprocket that is fixed for rotation with rear output shaft 36. Now, however, second sprocket 84′ is configured to have combined/integrated sprocket clutch drum 100 associated therewith. Thus, sprocket teeth 90′ of second sprocket 84′ are formed on the external surface of drum segment 156′ of combined sprocket clutch drum 100 while internal spline teeth 160′ are formed on the internal surface of drum segment 156′. Those skilled in the art can recognize and understand that transfer case 22C is substantially identical to transfer case 22 (FIGS. 2-5) with the exception that the arrangement of mode clutch 70 and transfer assembly 72 has been reversed.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A transfer case for a four-wheel drive vehicle having a powertrain and front and rear drivelines, the transfer case comprising:
a rear output shaft interconnecting the powertrain to the rear driveline;
a front output shaft interconnected to the front driveline;
a transfer assembly having a first transfer component, a second transfer component fixed for rotation with the front output shaft, and an intermediate transfer component drivingly interconnecting the first and second transfer components;
a mode clutch operable for coupling the first transfer member to the rear output shaft, the mode clutch including a clutch drum rotatably supported on the rear output shaft and a clutch pack operably disposed between the clutch drum and the rear output shaft; and
a clutch actuator operable to engage the clutch pack for coupling the clutch drum for rotation with the rear output shaft;
wherein the first transfer component is fixed to and radially surrounds the clutch drum.

2. The transfer case of claim 1 wherein the first transfer component is integrally formed with the clutch drum to define an integrated torque transfer component.

3. The transfer case of claim 1 wherein the first transfer component is a first sprocket formed on an outer surface of the clutch drum, wherein the second transfer component is a second sprocket fixed for rotation with the front output shaft, and wherein the intermediate transfer component is a continuous chain encircling and drivingly meshed with first sprocket teeth of the first sprocket and with second sprocket teeth of the second sprocket.

4. The transfer case of claim 3 wherein the clutch drum includes a radial plate segment and an axially-extending drum segment, wherein the first sprocket teeth are formed on an outer peripheral surface of the drum segment.

5. The transfer case of claim 4 wherein internal spline teeth are formed on an inner peripheral surface of the drum segment and which are configured to mate with external spline teeth formed on clutch plates of the clutch pack.

6. The transfer case of claim 1 wherein the clutch drum of the mode clutch includes a radial plate segment and an axially-extending drum segment, wherein the first transfer component is defined by teeth formed on an outer peripheral surface of the drum segment.

7. The transfer case of claim 6 wherein the clutch pack is operably disposed in a clutch chamber formed between the drum segment of the clutch drum and the rear output shaft, and wherein the drum segment has internal spline teeth formed on an inner peripheral surface of the drum segments that are configured to drivingly engage external splines on clutch plates of the clutch pack.

8. The transfer case of claim 6 wherein the teeth formed on the outer peripheral surface of the drum segment are sprocket teeth.

9. The transfer case of claim 1 wherein the clutch drum of the mode clutch includes a drum segment coaxial with the rear output shaft, wherein the first transfer component is a first sprocket formed on an outer peripheral surface of the drum segment, wherein the second transfer component is a second sprocket fixed to the first output shaft, and wherein the intermediate transfer component is a continuous chain drivingly interconnecting the first and second sprockets.

10. The transfer case of claim 9 wherein the first sprocket is defined by sprocket teeth integrally formed to extend outwardly from the outer peripheral surface of the drum segment.

11. A transfer case for a four-wheel drive motor vehicle having a powertrain and first and second drivelines, the transfer case comprising:
a first shaft adapted to transmit drive torque from the powertrain to the first driveline;
a second shaft adapted for interconnection to the second driveline;
a mode clutch having a clutch drum surrounding the first shaft, a clutch hub driven by the first shaft, and a clutch pack of alternating first and second clutch plates operably coupled between an inner surface of the clutch drum and the clutch hub;
a clutch actuator for actuating the mode clutch to couple the clutch drum for rotation with the first shaft; and
a transfer assembly having a first sprocket surrounding and drivingly coupled to an outer peripheral surface of the clutch drum, a second sprocket fixed for rotation with the second shaft, and a continuous chain encircling and drivingly interconnecting the first and second sprockets.

12. The transfer case of claim 11 wherein the first sprocket is integrally formed with the clutch drum.

13. The transfer case of claim 11 wherein the first sprocket is defined by external sprocket teeth extending outwardly from the outer surface of the clutch drum.

14. The transfer case of claim 13 wherein internal spline teeth are formed in the inner surface of the clutch drum and are configured to mate with external spline teeth formed on the first clutch plates.

15. The transfer case of claim 14 wherein the internal spline teeth and the external sprocket teeth are integrally formed in the clutch drum via a press operation.

16. A transfer case for a four-wheel drive vehicle having a powertrain and first and second drivelines, the transfer case comprising:
a first shaft adapted to transmit drive torque from the powertrain to the first driveline;
a second shaft adapted for connection to the second driveline; and
a mode clutch and power transfer arrangement including an integrated torque transfer component rotatably supported on one of the first and second shafts and having a clutch drum segment configured to include first sprocket teeth formed on an outer surface and spline teeth formed on an inner surface, a sprocket fixed for rotation with the other one of the first and second shafts and having second sprocket teeth, a power chain encircling and meshed with the first and second sprocket teeth, a clutch pack having first clutch plates coupled to the spline teeth on the inner surface of clutch drum segment and having second clutch plates coupled to the one of the first and second shafts, and a clutch actuator for engaging the clutch pack and transferring drive torque from the first shaft through the clutch pack, the integrated torque transfer component, the chain and the sprocket to the other one of the first and second shafts.

17. The transfer case of claim 16 wherein the integrated torque transfer component is rotatably supported on the first shaft and the sprocket is fixed to the second shaft, wherein the second clutch plates are drivingly coupled to the first shaft or a clutch hub fixed for rotation with the first shaft, and wherein the first sprocket teeth extend radially outwardly from the outer surface of the clutch drum segment of the integrated torque transfer component.

18. The transfer case of claim 17 wherein the integrated torque transfer components includes a radial plate segment connected to the clutch drum segment, and a cylindrical hub segment connected to the radial plate segment and which surrounds the first shaft, and wherein a bearing rotatably supports the hub segment on the first shaft.

19. The transfer case of claim 16 wherein the first sprocket teeth and spline teeth formed in the clutch drum segment have non-complimentary shapes.

20. The transfer case of claim 16 wherein the clutch pack is operably disposed in a clutch chamber defined between clutch drum segment and the one of the first and second shafts, and wherein the clutch actuator generates and applies a variable clutch engagement force on the clutch pack.
